(19) United States
(12) Patent Application Publication
(10) Pub. No.: US 2015/0195995 A1
(43) Pub. Date: Jul. 16, 2015

(54) SMALL FOOTPRINT GREEN ROOF OPTIMIZED FOR CLIMBING PLANTS

(71) Applicant: THE JOHNS HOPKINS UNIVERSITY, Baltimore, MD (US)

(72) Inventor: Justin Anthony Falcone, Cinnaminson, NJ (US)

(21) Appl. No.: 14/596,372

(22) Filed: Jan. 14, 2015

Related U.S. Application Data
(60) Provisional application No. 61/927,077, filed on Jan. 14, 2014.

(51) Int. Cl. A01G 9/00

(52) U.S. Cl. CPC A01G 9/00

(57) ABSTRACT

The present invention is directed to a system for a green roof that allows a green roof to be used more affordably and in a broader range of situations than currently available. The system includes a network of grow chambers suspended above the roof. The network of grow chambers are interconnected by a grow matrix. The grow matrix is formed from a material such as wires, which also allow the plants in the grow chambers to climb and expand over the roof. The system also includes structural supports to provide stability to the system and to suspend the matrix in areas where there is no grow chamber. The system can be installed on different roof configurations, including pitched roofs, and need not be installed over the entire surface area of the roof. In addition, the system can include irrigation in the form of sprinklers, drip watering, or water reservoirs.

### CROSS-REFERENCE TO RELATED APPLICATIONS

This application claims the benefit of U.S. Provisional Patent Application No. 61/927,077 filed on Jan. 14, 2014, which is incorporated by reference, herein, in its entirety.

### FIELD OF THE INVENTION

The present invention relates generally to green roofing. More particularly, the present invention relates to a system for providing a lightweight, small footprint green roof.

### BACKGROUND OF THE INVENTION

A green roof is a partial or complete cover for a roof, including vegetation and a growing medium. The system often includes a waterproof membrane to protect the roof below, and also may include additional layers, such as a root barrier, drainage, and/or irrigation systems. A green roof can provide many benefits for a building, such as absorbing rainwater, providing insulation, creating a habitat for wildlife, and helping to lower urban air temperatures and mitigate the heat island effect.

Market available green roof systems fall into two principle categories: conventional and modular. Both categories of systems create an artificial planting bed affixed over every square foot of the roof that is to be greened. Therefore, these conventional green roofs can become very heavy, and may likely only be supportable by a flat roof, leaving out consumers with pitched or architecturally complicated roofs. Additionally, conventional, currently available green roof systems generally need to be installed by a professional, increasing cost of obtaining and maintaining a green roof.

Accordingly, there is a need in the art for a green roof system that is affordable and easy to install on many types of existing roofs.

### SUMMARY OF THE INVENTION

The foregoing needs are met by the present invention which provides a system for creating a green roof including two or more grow chambers for mounting to a roof. The two or more grow chambers are configured for holding a planting substrate and a plant. The system also includes a grow matrix for connecting the two or more grow chambers. The grow chambers and the grow matrix are configured to be connected to one another.

In accordance with an aspect of the present invention, the system further includes structural supports configured to be connectable to the grow matrix and also configured to suspend the grow matrix in areas without grow chambers. A roof mount configured to connect the grow chamber to the roof is also included. The system includes a support for coupling the roof mount to the grow chamber. Additionally, the two or more grow chambers are suspended above the roof in a range of approximately 20 cm to approximately 25 cm.

In accordance with another aspect of the present invention the system can include a water reservoir disposed such that the plant can wick moisture from the water reservoir. The water reservoir can include water drainage holes. Alternately or in addition, the system can include a sprinkler system or a drip watering system.

In accordance with yet another aspect of the present invention, the grow matrix can be formed using a wire. The grow matrix can also include a network of wires. In addition, the system can be configured such that there is approximately 3 meters between each of the two or more grow chambers.

In accordance with another aspect of the present invention, a method of creating a green roof includes obtaining two or more grow chambers for mounting to a roof, wherein the two or more grow chambers are configured for holding a planting substrate and a plant. The method also includes combining the two or more grow chambers with a grow matrix for connecting the two or more grow chambers, wherein the grow chambers and the grow matrix are configured to be connected to one another.

In accordance with still another aspect of the present invention, the method includes using a roof mount configured to connect the grow chamber to the roof. The method also includes using structural supports configured to be connectable to the grow matrix and also configured to suspend the grow matrix in areas without grow chambers. The method includes suspending the two or more grow chambers being above the roof in a range of approximately 20 cm to approximately 25 cm. Additionally, the method includes irrigating the plant with a water reservoir disposed such that the plant can wick moisture from the water reservoir. Irrigation can also be achieved with a sprinkler system or a drip watering system. Approximately 3 meters is used as an average spacing between each of the two or more grow chambers.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 illustrates a schematic diagram of a system for a green roof, according to an embodiment of the present invention.

FIG. 2 illustrates a side view of a system for a green roof, according to an embodiment of the present invention.

FIG. 3 illustrates another embodiment of a system for a green roof, according to the present invention.

FIG. 4 illustrates a climate zone map of the United States, for determining appropriate plants to use with the present invention in different climates.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains, having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The present invention is directed to a system for a green roof that allows a green roof to be used more affordably and in a broader range of situations than currently available. The system includes a network of grow chambers suspended above the roof. The network of grow chambers are interconnected by a grow matrix. The grow matrix is formed from a material such as wires, which also allow the plants in the grow chambers to climb and expand over the roof. The system also includes structural supports to provide stability to the system and to suspend the matrix in areas where there is no grow chamber. The system can be installed on different roof configurations, including pitched roofs, and need not be installed over the entire surface area of the roof. In addition, the system can include irrigation in the form of sprinklers, drip watering, or water reservoirs.

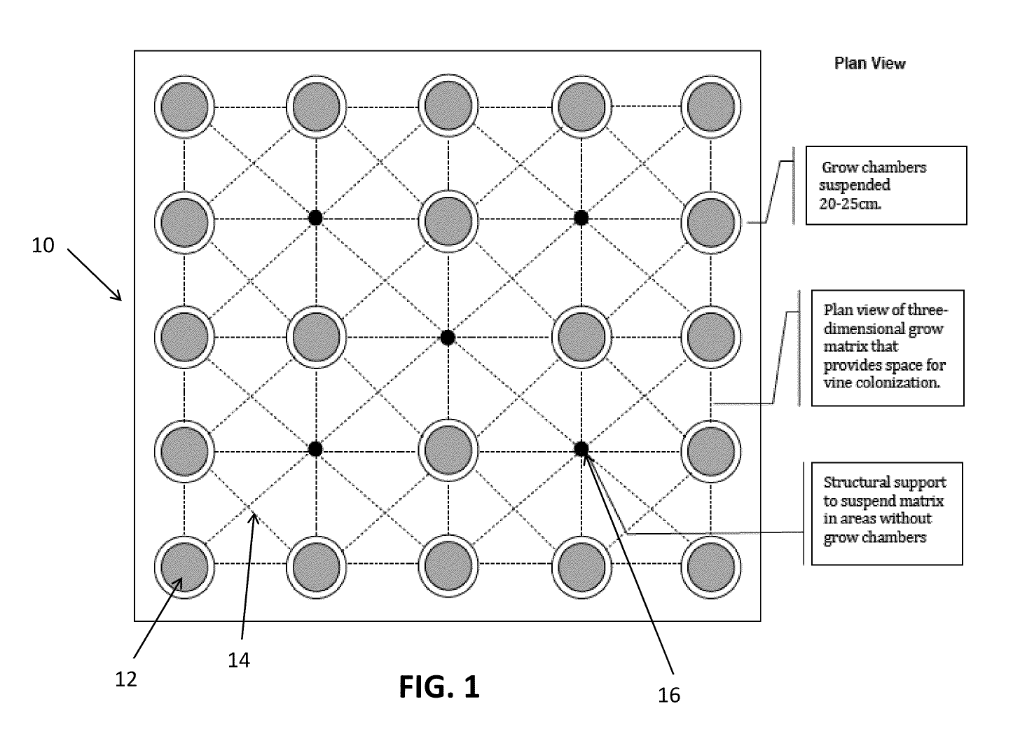

FIG. 1 illustrates a schematic diagram of a system for a green roof, according to an embodiment of the present invention. As illustrated in FIG. 1, the system 10 includes grow chambers 12 distributed over a surface area of a roof to be covered by the system 10. The system also includes a grow matrix 14 that connects the grow chambers 12 as well as structural supports 16 to suspend the grow matrix 14 in areas with no grow chambers 12. The grow chamber 12 is configured to hold a planting substrate, such as soil, and at least one plant. Exemplary plants for use with the present invention will be described in further detail below.

Further as illustrated in FIG. 1, the grow chambers 12 are suspended approximately 20 to 25 cm above the roof surface to be covered. The grow chambers 12 can all be uniform in size, or can vary in size depending on the position in the system 10. Additionally, the grow chambers 12 can take the form of a traditional planting pot and can include special features to facilitate inclusion in the system 10, such as a slanted base, connectors for facilitating connection to the grow matrix, and a water reservoir for collecting rain water or excess water from watering to hydrate the plants. The grow chambers 12 and grow matrix 14 are arranged in such a way as to distribute weight across the surface area of the roofing surface. The grow chambers 12 and grow matrix 14 can also be arranged such that the grow chambers 12 sit on top of structural supports for the roof, such that the extra weight is being borne by stronger areas of the roof. The structural supports 16 can be placed in any area where grow chambers are not needed or in areas where it might not be desirable to place extra weight on the roof. Depending on the type of plant chosen for the grow chamber 12, the grow matrix 14 can also be used as for support for creeping plants, such as vines. In this way, the entire roofing surface can be covered with vegetation without plantings and soil covering the entire surface area of the roof.

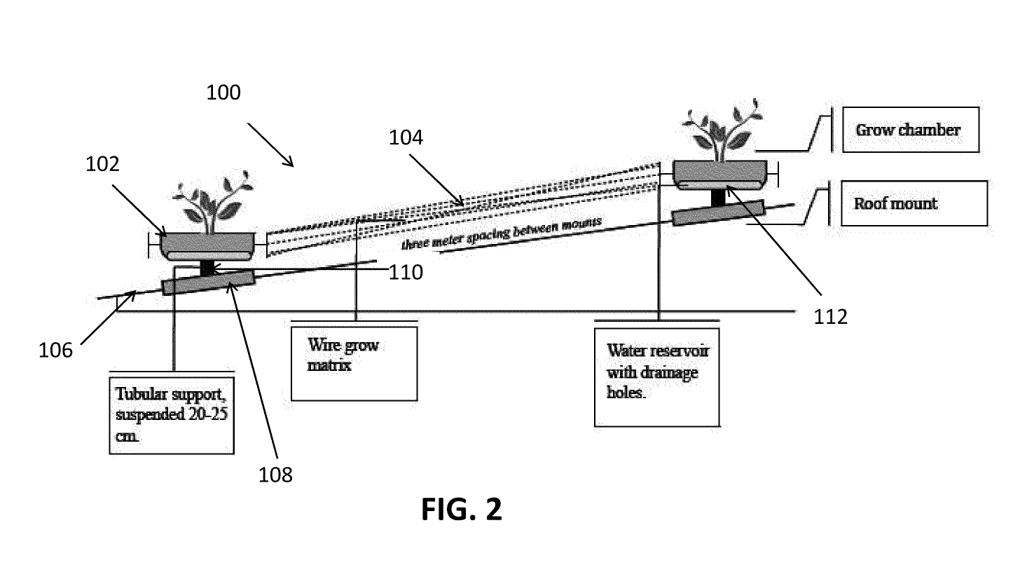

FIG. 2 illustrates a side view of a system for a green roof, according to an embodiment of the present invention. As illustrated in FIG. 2, a system 100 includes two grow chambers 102 connected by a grow matrix 104. While two grow chambers are shown in FIG. 2, any suitable number of grow chambers can be used to cover the desired surface area of the roof. The grow chambers 102 are separated by approximately three meters of space, as illustrated in FIG. 2. However, this is included by way of exemplary setup, and any suitable spacing for a given roof or portion of a roof can be used. As illustrated in FIG. 2, the grow matrix 104 is formed from wire, but any other suitable material known to or conceivable by one of skill in the art could be used. For instance, pre-assembled lattice matrices made from mesh or synthetic materials may be used to bridge grow chambers 102.

The grow chamber 102 is fixed to the roof 106, using roof mount 108. The grow chamber 102 is connected to the roof mount 106 with a tubular support 110. The tubular support 110 is approximately 20-25 cm in height and suspends the grow chamber off of the surface of the roof. The grow chamber 102 can also include a water reservoir 112 with drainage holes for keeping the plants in the grow chamber 102 hydrated. Plant roots can wick water stored in the reservoir to sustain growth in periods of intermediate drought. In addition, the grow chamber 102 can include connectors 114 for connecting the grow chambers together using the grow matrix 104. The grow chamber 102 can include connectors 114 all around the edge of the chamber in order to facilitate connection of grow chambers 102 in any number of configurations. The grow chamber 102 can also be removed from the tubular support 110 if roof maintenance needs to be done or if a plant dies and needs to be exchanged. It should also be noted that the system 100 can be sold in a self-install kit designed to green a roof in square meter units. The kit could include the grow chambers, connectors, and water reservoirs necessary to cover the number of square meters, as well as grow matrix to connect the grow chambers. The system could also be sold wholesale to construction and garden professionals for assisted and new construction installation.

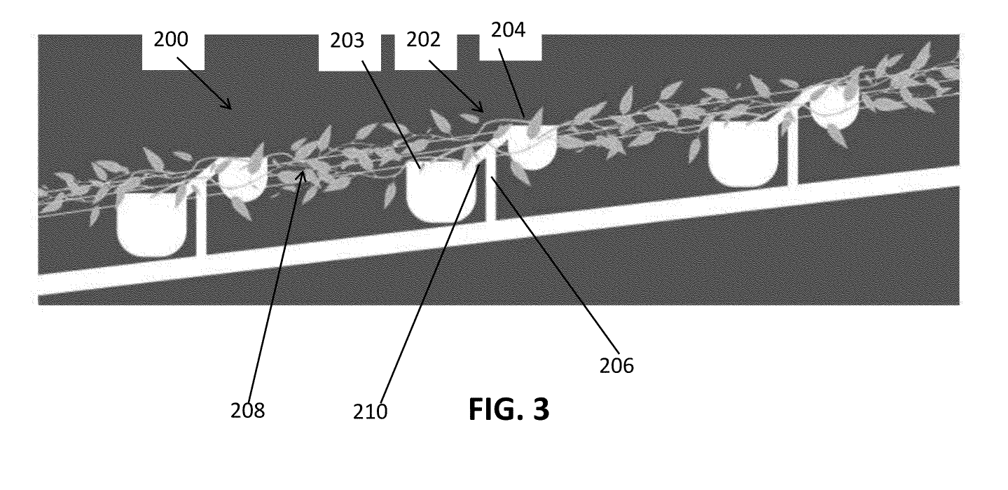

FIG. 3 illustrates another embodiment of a system for a green roof, according to the present invention. The system 200 includes grow chambers 202 having plant pods 203 and 204 extending from a tubular support 206. The grow chambers 202 are interconnected using a grow matrix 208. The grow matrix 208 can be formed from wire or any other suitable material, as described above. The tubular supports 206 are mounted to the roof at one end and can include an angled portion 210 for connecting plant pods 203 and 204. As described above, the grow chambers 202 can include a water reservoir, the system can include a means for watering such as a sprinkler or drip watering system, or can rely on rain or occasional watering for water supply.

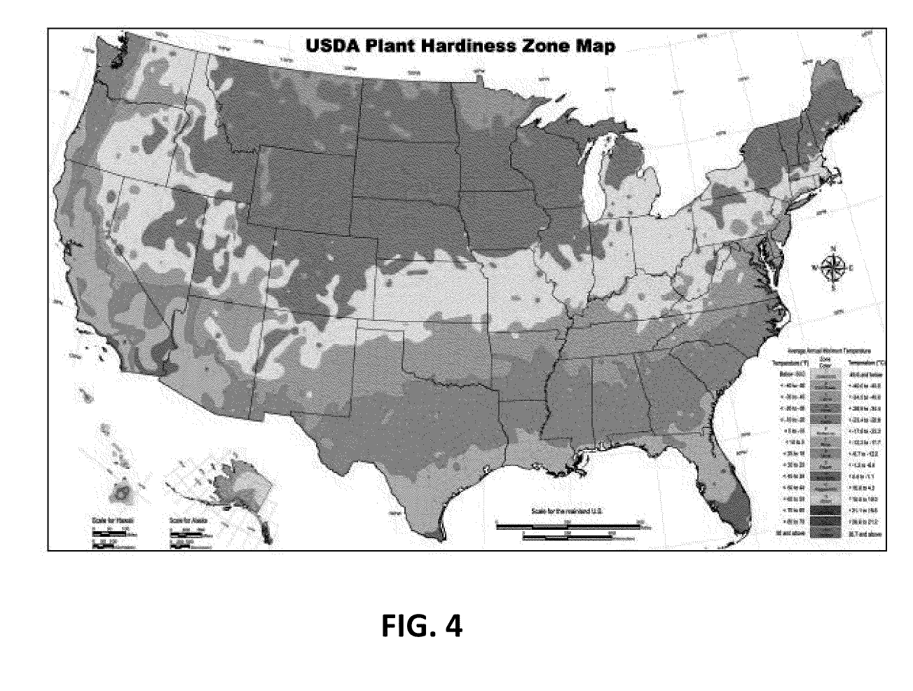

Localized climate conditions will dictate the specific varieties of plants used to colonize the grow chambers. Table 1 is included herein as an exemplary list of plants that may work well in the system of the present invention. The list provided in Table 1 is merely by way of example and is not considered to be an exhaustive list of the possible plants that could be used in conjunction with this system. FIG. 4 is also included to illustrate the US geographic location for the climate zones noted in the table, below.

| Plant Name | Flowering | Native to the US | Drought Tolerant | Deciduous | Climate Zone |
|---|---|---|---|---|---|
| American Wisteria | Yes | Yes | Yes | Yes | 3-9 |
| (Wisteria frutescens) | | | | | |
| Trumpet vine | Yes | Yes | Yes | Yes | 4-9 |
| (Campsis radicans) | | | | | |
| Clematis | Yes | Domestic and | Dependent on | Both evergreen | 4-9 |
| (Clematis) | | international | subspecies | and deciduous | |
| | | varieties | | subspecies exist | |
| Chocolate Vine | No | Native to Japan | Yss | Evergreen in | 4-8 |
| (Akebia quinata) | | | | zones 6+ | |
| Grapes | Yes (Fruit | Domestic and | No (Although | No (evergreen) | 3-10 |
| (Vitis) | bearing) | international | drought tolerant | | |
| | | varieties | varieties have | | |
| | | | been engineered) | | |
| Evergreen honeysuckle | Yes | Yes | Yes | No (evergreen) | 3-9 |
| (Lonicera henryi) | | | | | |

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for creating a green roof comprising:
two or more grow chambers for mounting to a roof, wherein the two or more grow chambers are configured for holding a planting substrate and a plant; and,
a grow matrix for connecting the two or more grow chambers, wherein the grow chambers and the grow matrix are configured to be connected to one another.

2. The system of claim 1 further comprising structural supports configured to be connectable to the grow matrix and also configured to suspend the grow matrix in areas without grow chambers.

3. The system of claim 1 further comprising a roof mount configured to connect the grow chamber to the roof.

4. The system of claim 3 further comprising a support for coupling the roof mount to the grow chamber.

5. The system of claim 1 further comprising the two or more grow chambers being suspended above the roof in a range of approximately 20 cm to approximately 25 cm.

6. The system of claim 1 further comprising a water reservoir disposed such that the plant can wick moisture from the water reservoir.

7. The system of claim 6, wherein the water reservoir further comprises water drainage holes.

8. The system of claim 1 further comprising a sprinkler system.

9. The system of claim 1 further comprising a drip watering system.

10. The system of claim 1 wherein the grow matrix further comprises a wire.

11. The system of claim 1 wherein the grow matrix further comprises a network of wires.

12. The system of claim 1 wherein there is approximately 3 meters between each of the two or more grow chambers.

13. A method of creating a green roof comprising:
obtaining two or more grow chambers for mounting to a roof, wherein the two or more grow chambers are configured for holding a planting substrate and a plant; and,
combining the two or more grow chambers with a grow matrix for connecting the two or more grow chambers, wherein the grow chambers and the grow matrix are configured to be connected to one another.

14. The method of claim 13 further comprising using a roof mount configured to connect the grow chamber to the roof.

15. The method of claim 13 further comprising using structural supports configured to be connectable to the grow matrix and also configured to suspend the grow matrix in areas without grow chambers.

16. The method of claim 13 further comprising suspending the two or more grow chambers being above the roof in a range of approximately 20 cm to approximately 25 cm.

17. The method of claim 13 further comprising irrigating the plant with a water reservoir disposed such that the plant can wick moisture from the water reservoir.

18. The method of claim 13 further comprising irrigating with a sprinkler system.

19. The method of claim 13 further comprising irrigating with a drip watering system.

20. The method of claim 13 further comprising leaving approximately 3 meters between each of the two or more grow chambers.
